(19) United States
(12) Patent Application Publication
(10) Pub. No.: US 2021/0241138 A1
(43) Pub. Date: Aug. 5, 2021

(54) VEHICLE POWERTRAIN ANALYSIS IN NETWORKED FLEETS

(71) Applicant: Ford Global Technologies, LLC, Dearborn, MI (US)

(72) Inventors: Dominique Meroux, Fair Oaks, CA (US); Zhen Jiang, Mountain View, CA (US); Cassandra Telenko, San Francisco, CA (US)

(73) Assignee: Ford Global Technologies, LLC, Dearborn, MI (US)

(21) Appl. No.: 16/781,698

(22) Filed: Feb. 4, 2020

(51) Int. Cl. G06N 5/04; G07C 5/08; G06N 5/02; G06Q 10/00; G06Q 30/02

(52) U.S. Cl. CPC G06N 5/04; G07C 5/085; G06N 20/00; G06Q 10/20; G06Q 30/0283; G06N 5/02

(57) ABSTRACT

A computer-implemented method for generating recommendations for vehicle powertrain changes is described herein. Disclosed systems and methods include receiving operational data associated with one or more vehicles in a fleet of networked vehicles, and receiving maintenance data associated with the vehicles. The maintenance data can include a vehicle parts history associated with one or more fleet vehicle parts. A machine learning analytical model is described that determines, based in part on the operational data and the maintenance data, a total cost of ownership for the vehicles, and generates, based at least in part on the total cost of ownership for the vehicles, a vehicle recommendation indicative of a powertrain changes for the vehicles in the fleet. Aspects of the present disclosure may provide automated sources of crowdsourced vehicle fleet information with which vehicle fleet managers can make actionable decisions for fleet powertrain upgrades.

### TECHNICAL FIELD

The present disclosure relates to vehicle powertrain analysis, and more particularly, to systems and methods for optimizing vehicle powertrain configurations.

### BACKGROUND

When a decision is made for a group of vehicles operating as part of a networked vehicle fleet, the factors that affect cost and benefits for powertrain configurations can vary widely, and may require substantial data input that represents actual proposed uses of the vehicles in the fleet. Using conventional fleet management techniques and systems, the time and effort required to obtain reliable and accurate representative data may be untenably inefficient. Current techniques may not consider lifecycle operating data associated with each vehicle, such as, for example, environmental conditions, operating conditions (e.g., mountain driving, city driving, drive time calculations, engine speed, idle time, damage event records, weather, etc. Such information may be useful to evaluate and predict a total lifecycle cost of fleet vehicle ownership in view of a particular powertrain option.

Although some known methods may track lifecycle cost-of-ownership for vehicles in a vehicle fleet, the conventional methods may fail to track operation and maintenance conditions, track expenses, or provide authentication functionality to verify the type and quality of work performed on the vehicles in the fleet. Moreover, known techniques may not predict and quantify uncertainty of customer-specific total cost of ownership within predetermined ranges of precision over a vehicle lifecycle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a functional schematic of an example automotive computer utilized in accordance with the present disclosure.

FIG. 3 is block diagram of an example computer utilized in accordance with the present disclosure.

FIG. 4 is a flowchart of an example method for generating a vehicle recommendation indicative of a powertrain change for a vehicle, according to the present disclosure.

FIG. 5 depicts an example data structure in a database utilized in accordance with the present disclosure.

### DETAILED DESCRIPTION

### Overview

The systems and methods disclosed herein are configured to track crowdsourced cost-of-ownership data associated with vehicles in a networked vehicle fleet, and provide vehicle powertrain recommendations using a machine learning analytical model. In some aspects, the system may include a cloud-based portion configured and/or programmed to track vehicle-level and fleet-level operating conditions, track vehicle maintenance information, and track related expenses associated with vehicle ownership. The system may also include a vehicle-based portion that tracks maintenance events, operating conditions, and other aspects associated with particular vehicles. The vehicle-based portion may monitor maintenance and other events, using a vehicle telematics system(s) (among other tools), contextualize information associated with the vehicle(s), and report the contextualized information to one or more cloud-based centralized server(s). The system(s) may alternate between vehicle(s) and cloud-based infrastructure such that vehicles, and in some embodiments, specific vehicle parts, are tracked from manufacture to retirement from use in order to capture an accurate estimation of cost of ownership for the vehicle over its lifecycle in the fleet.

The tracked information can include maintenance data associated with the vehicle, which may provide specific and measurable information associated with how a vehicle in the fleet has been maintained, and also include operational information that quantifies a vehicle is used in the fleet. For example, the maintenance data can include individual vehicle-level maintenance information that includes identification for service personnel and organizations that have serviced the vehicle(s), and that include date, time, and other detailed information associated with vehicle repairs. The disclosed system(s) may utilize visual recognition systems that are installed and operable onboard the vehicles in the fleet to determine what maintenance was performed, and determine qualitative information associated with the maintenance such that the overall maintenance for the vehicle may be quantified and compared against other information to determine a path forward with respect to powertrain changes. In some aspects, this qualitative information include and/or incorporate maintenance details, such as (for example) a parts history of particular parts installed and/or replaced on each respective vehicle. The qualitative information may further include vehicle use information such as, for example, vehicle location tracking, weather information, vehicle use, and other factors. The operational data may include information from the on-board telematics system and/or the cloud-based infrastructure, that details particular vehicle usage and information.

The vehicle can also track sensor information of use, emissions, and environmental conditions to assess predicted parts degradation. The disclosed systems may use blockchain and/or other techniques to authenticate vehicle and parts data, and to distribute invoices associated with particular vehicle maintenance. On-vehicle sensors may detect and verify types and locations of maintenance performed. For example, a refueling station may automatically transmit an invoice pertaining to the vehicle. Vehicle sensors can further verify the quantity of fuel received.

Using the cloud-based and vehicle-based infrastructure to obtain crowdsourced information from the vehicle fleet in real-time (and/or substantially real-time) may save valuable time and significantly increase the accuracy of the data. The data obtained by the disclosed systems may have enhanced levels of accuracy and reliability because the vehicle and authentication network may provide immutable sources for the data, while resolving the reporting inconsistencies associated with conventional systems. Machine learning techniques may be utilized to generate actionable vehicle recommendations that recommend powertrain changes that optimize real-world factors specific to the fleet vehicles under consideration.

These and other advantages of the present disclosure are provided in greater detail herein.

### Illustrative Embodiments

The disclosure will be described more fully hereinafter with reference to the accompanying drawings, in which exemplary embodiments of the disclosure are shown, and not intended to be limiting.

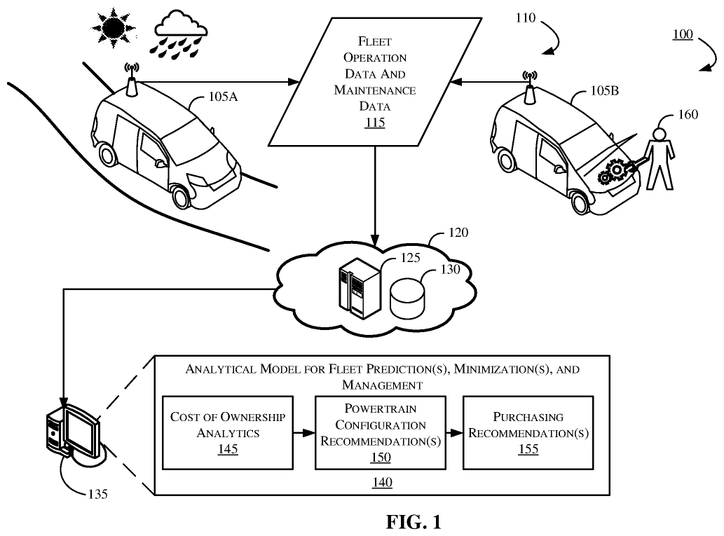

As illustrated in FIG. 1, an operating environment 100 is depicted in which techniques and structures for providing the systems and methods disclosed herein may be implemented. The operating environment 100 shown in FIG. 1 includes one or more vehicle(s) 105A and 105B. Although two vehicle(s) 105A, 105B are depicted in FIG. 1, it is appreciated that the operating environment 100 may include any number of vehicle(s), where the vehicles 105A and 105B (referred to hereafter collectively as vehicles(s) 105) may represent a single vehicle, and/or any number of vehicles in a fleet 110. Collectively, the vehicle(s) 105 may operate as a single or multiple-vehicle fleet, which may (in multiple vehicle embodiments) be communicatively coupled to a server(s) 125 via a network(s) 120. The network(s) 120 may be and/or include a vehicle-to-vehicle communication system, a private network, public network, and/or other known communications infrastructure described in greater detail hereafter.

The server(s) 125 may be and/or include one or more mainframes, one or more Reduced Instruction Set Computers (RISCs) and/or architecture-based servers, one or more blade servers, or other cloud-based computing infrastructure. The one or more server(s) 125 may include and/or be communicatively coupled with one or more storage devices 130. In one or more example embodiments, the server(s) 125 may receive fleet operation data and maintenance data 115 (hereafter collectively referred to as “vehicle data 115”) from the vehicle(s) 105 in the fleet 110, and determine, at least in part based on the vehicle data 115, a total cost of lifecycle ownership for the vehicles in the fleet 110. The vehicle data 115 may include, for example, identification information associated with service technician(s) 160 that have serviced the vehicle(s) 105.

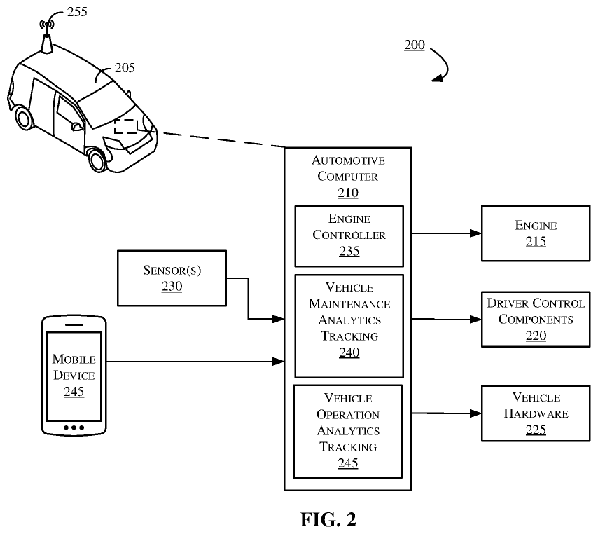

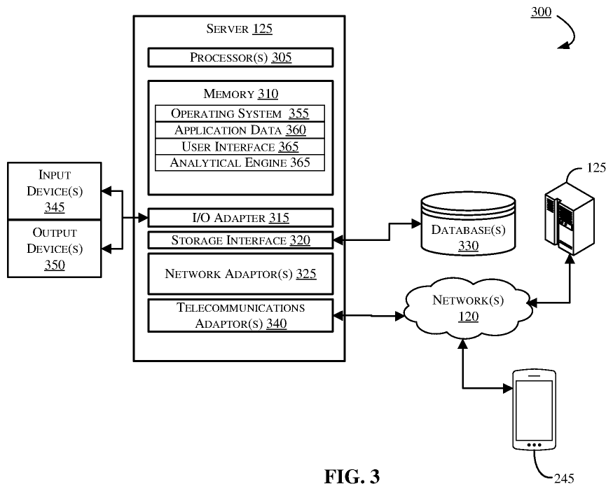

The server(s) 125 may be configured to perform aspects of the present disclosure both alone, and in conjunction with automobile computing devices installed on-board the vehicle(s) 105. One such example is an automotive computer 210, described hereafter with respect to FIG. 2. Stated in another way, the server(s) 125 may include computer-executable instructions that, when executed by a processor), perform aspects of the present disclosure. For example, one or more processor(s) 305 (FIG. 3) of the server(s) 125 may work in conjunction with one or more processors of an automotive computer associated with one or more of the vehicle(s) 105 to compile, categorize, and/or contextualize the vehicle data 115.

The server(s) 125 and/or a fleet manager computing system 135 may perform these steps using an analytical model for fleet prediction(s) minimization(s), and management 140 (hereafter “the analytical model 140”). Accordingly, the server(s) 125 may generate, based at least in part on total cost of lifecycle ownership analytics 145 for the vehicle(s) 105, and one or more vehicle powertrain configuration recommendation(s) 150. The server(s) 125 may also generate one or more messages comprising purchasing recommendation(s) 155 based at least in part on the recommendation(s) 150.

FIG. 2 illustrates an example automotive computing system 200 that can include an automotive computer 210, that may be disposed in an engine compartment or other location of one or more vehicle(s) 205 (or elsewhere in the vehicle(s) 205) as part of the system 200 in accordance with the disclosure.

The vehicle(s) 205 may be a car, truck, or other type of passenger vehicle, a bus or other type of multiple passenger vehicle, a work vehicle, work machine, or other vehicle not shown or explicitly discussed herein. The vehicle(s) 205 may be substantially similar to the vehicle(s) 105 described with respect to FIG. 1, and may include an engine 215 (which may be electric, gasoline, hybrid, etc.), one or more driver control component(s) 220, vehicle hardware 225, and one or more sensor(s) 230.

In some cases, the engine 215 may be customizable to allow operation of the vehicle(s) 205 as described with respect to embodiments described herein, and may be controlled using an engine controller 235 (which may be, in some aspects, an autonomous vehicle controller, a semi-autonomous vehicle controller, and/or another type of vehicle control module).

In some aspects, the sensor(s) 230 may include one or more audio and/or video input devices, such as a camera or other sensing mechanisms, that may be configured for receiving information indicative of vehicle operational conditions, maintenance data, vehicle damage event data, and other information. For example, one or more proximity sensors, piezoelectric sensors, or other type(s) of sensor may be configured to produce signal feedback information indicative of whether a damage event has damaged one or more parts. Additionally, the sensor(s) 230 may include one or more navigational receiver(s) such as, for example, a global positioning system (GPS. 100231 The sensor(s) 230 may include a visual recognition system having a camera, a microphone, and one or more proximity sensors configured to recognize human activity and interaction with the vehicle. For example, the visual recognition system may recognize individuals servicing the vehicle, and to recognize events during the day-to-day use of the vehicle such as, for example, refueling and driving. In another embodiment, the sensor(s) 230 may include a facial recognition system configured to determine one or more identities of individuals servicing the vehicle (e.g., the service technician(s) 160 depicted in FIG. 1). The visual recognition system may also determine businesses associated with vehicle service, such as maintenance or mechanic facilities, etc. In one embodiment, the visual recognition system may determine a location based at least in part on a sign or other identifying feature of the service technician(s) 160 place(s) of business.

In an embodiment, the sensor(s) 230 may receive data such as refueling information, and other information described herein. For example, the sensor(s) 230 may function as part of a vehicle telematics system(s) that may work in conjunction with on-vehicle visual recognition system(s) that monitor maintenance and other events. The sensor(s) 230 may include various types of fuel sensors that may determine a quality and/or quantity of fuel used for the vehicle. For example, in an embodiment, the sensor(s) 230 may include one or more fuel-type sensors configured to evaluate a fuel quality, a fuel type, and/or other information associated with a refueling event. In one non-limiting example, the sensor(s) 230 may provide vehicle maintenance information that includes part-specific information, such as, for example, a radio frequency identification device (RFID) tag associated with a mechanical or electrical part installed on the vehicle(s) 205. In another aspect, the maintenance data may include parts data indicative of a part repair or part replacement associated with the vehicle(s) 205.

The automotive computer 210 may further include vehicle maintenance analytics tracking 240, and a vehicle operation analytics tracking system 250. One or more mobile device(s) 245 may be configured to communicate data to and from the automotive computer 210 using one or more wireless and/or wired communications protocols described herein. For example, one or more wireless transceiver(s) 255 may communicate information to and from the automotive computer 210 via the network(s) 120 (depicted in FIG. 1).

FIG. 3 illustrates a block diagram of an exemplary cloud-based computing system 300 (hereafter “Computer 300”) for use in practicing the embodiments described herein. The computer 300, as described herein, can be implemented in hardware, software (e.g., firmware), or a combination thereof.

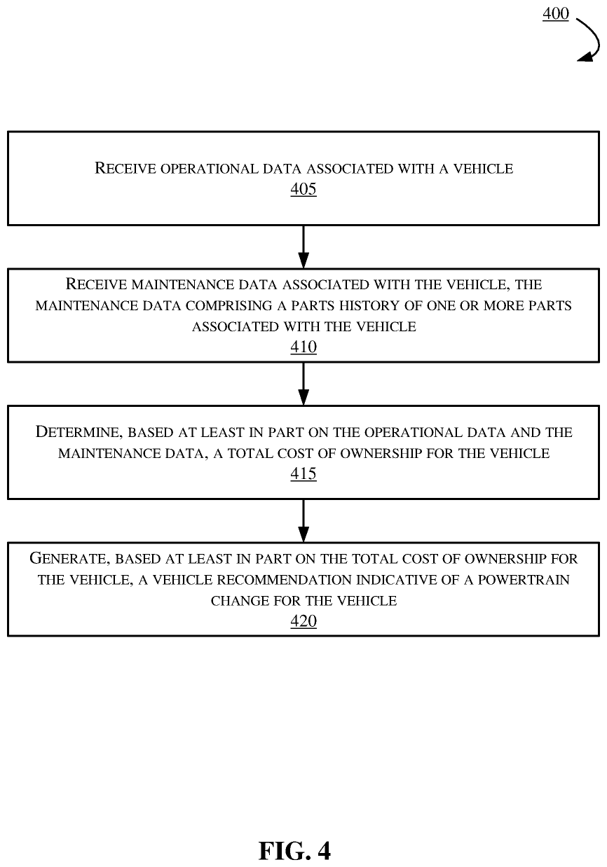

As shown in FIG. 3, the computer 300 may include the one or more processor(s) 305, a memory 310 communicatively coupled to the one or more processor(s) 305, and one or more input/output adapters 315 that can communicatively connect with external devices. Example external devices can include, for example, the automotive computer 210, the mobile device 245, etc. The computer 300 may operatively connect to and communicate information with one or more internal and/or external memory devices storing one or more database(s) via a storage interface 320. In one example embodiment, the database(s) may include one or more fleet-level database(s) 400 as described hereafter with respect to FIG. 4.

The computer 300 may include one or more network communications adapter(s) 325 enabled to communicatively connect the computer 300 with one or more networks 120. In some example embodiments, the network(s) 120 may be or include a telecommunications network infrastructure, which may connect the mobile device 245 with the server(s) 125. In such embodiments, the computer 300 can further include one or more telecommunications adaptor(s) 340. The computer 300 may further include and/or connect with one or more input devices 345 and/or one or more output devices 350 through the I/O adapter(s) 315.

The one or more processor(s) 305 are collectively a hardware device for executing program instructions (aka software), stored in a computer-readable memory (e.g., the memory 310). The one or more processor(s) 305 can be a custom made or commercially-available processor, a central processing unit (CPU), a plurality of CPUs, an auxiliary processor among several other processors associated with the server(s) 125, a semiconductor based microprocessor (in the form of a microchip or chip set), or generally any device for executing instructions.

The one or more processor(s) 305 may be disposed in communication with one or more memory devices (e.g., the memory 310 and/or one or more external database(s) 330, etc.) via a storage interface 320. The storage interface 320 can also connect to one or more memory devices including, without limitation, one or more database(s) 330, and/or one or more other memory drives (not shown in FIG. 2) including, for example, a removable disc drive, a vehicle computing system memory, cloud storage, etc., employing connection protocols such as serial advanced technology attachment (SATA), integrated drive electronics (IDE), universal serial bus (USB), fiber channel, small computer systems interface (SCSI), etc.

The memory 310 can include any one or a combination of volatile memory elements (e.g., dynamic random access memory (DRAM), synchronous dynamic random access memory (SDRAM), etc.) and can include any one or more nonvolatile memory elements (e.g., erasable programmable read only memory (EPROM), flash memory, electronically erasable programmable read only memory (EEPROM), programmable read only memory (PROM), etc.

The instructions in the memory 310 can include one or more separate programs, each of which can include an ordered listing of computer-executable instructions for implementing logical functions. In the example of FIG. 3, the instructions in the memory 310 can include an operating system 355. The operating system 355 can control the execution of other computer programs such as, for example cost of ownership analytics 145 which may be configured and/or programmed to generate one or more powertrain configuration recommendation(s) 150, and/or provide scheduling, input-output control, file and data management, memory management, and communication control and related services.

In one example, the memory 310 may include instructions for generating vehicle recommendation(s) indicative of powertrain changes for the vehicles in the fleet 110. For example, the processor(s) 305 may execute the instructions in the memory 310 to perform various acts described herein that generate one or more vehicle recommendation that can indicate one or more powertrain changes for the vehicle(s) 105, 205, etc. For example, the processor(s) 305 may determine the cost of lifecycle ownership using an analytical method (described hereafter in greater detail), which may be based on the fleet operation and maintenance data 115 (depicted in FIG. 1).

In one example embodiment, the processor(s) 305 may perform analytical steps using the cost of ownership value(s), including determining one or more mean values of vehicle data. The processor(s) 305 may generate one or more set(s) of weighted information using the instructions in the memory 310, such as, for example, powertrain selection constraints. For example, the instructions, when executed by the one or more processor(s) 305, may cause the processor(s) to perform acts including determining a first standard deviation value associated with a first powertrain design option, determining a second standard deviation value associated with a second powertrain design option, and weighting the first standard deviation value and the second standard deviation value with one or more operations constraint values of a set of predetermined operations constraint values.

Accordingly, the processor(s) 305 may store information in or more data stores communicatively coupled with the server(s) 125. In one aspect, the server(s) 125 may access the database(s) 330 to retrieve information needed for calculation(s) described herein, such as, for example, a set of predetermined operations constraint values (which may be known and/or experimentally determined values associated with drivetrain workload, drive range of particular electric and/or hybrid drivetrain configurations, etc.) stored as part of the database(s) 330.

The program instructions stored in the memory 310 can further include application data 360, and instructions for controlling and/or interacting with the computer 300.

The I/O adapter 315 can connect a plurality of input devices 345 to the server(s) 125. The input devices can include, for example, a keyboard, a mouse, a microphone, a sensor, etc. The output device 350 can include, for example, a display, a speaker, a touchscreen, etc.

The I/O adapter 315 can further include a display adapter coupled to one or more displays. The I/O adapter 315 can be configured to operatively connect one or more input/output (I/O) devices 350 to the server(s) 125. For example, the I/O adapter 315 can connect a keyboard and mouse, a touchscreen, a speaker, a haptic output device, or other output device. The output devices 350 can include but are not limited to a printer, a scanner, and/or the like. Other output devices can also be included, although not shown in FIG. 3. Finally, the I/O devices connectable to the I/O adapter 315 can further include devices that communicate both inputs and outputs, for instance but are not limited to, a network interface card (NIC) or modulator/demodulator (for accessing other files, devices, systems, or a network), a radio frequency (RF) or other transceiver, a telephonic interface, a bridge, a router, and the like.

According to some example embodiments, the server(s) 125 can include a mobile communications adapter 340. The mobile communications adapter 340 can include global positioning system (GPS), cellular, mobile, and/or other communications protocols for wireless communication.

In some embodiments, the server(s) 125 can further include a communications adapter 340 for coupling to the one or more network(s) 120.

The network(s) 120 can be and/or include Internet protocol (IP)-based network(s) for communication between the server(s) 125 and any external device. The network(s) 120 may transmit and receive data between the server(s) 125 and devices and/or systems external to the server(s) 125. In an exemplary embodiment, the network(s) 120 can be a managed IP network administered by a service provider. The network(s) 120 can be implemented in a wireless fashion, e.g., using wireless protocols and technologies, such as Wi-Fi, WiMAX, etc. The network(s) 120 can also connect with and/or include a wired network, e.g., an Ethernet network, a controller area network (CAN), etc., having any wired connectivity including, e.g., an RS232 connection, etc. The network(s) 120 can also be and/or include a packet-switched network such as a local area network, wide area network, metropolitan area network, the Internet, or other similar type of network environment. The network(s) 120 can be a fixed wireless network, a wireless local area network (LAN), a wireless wide area network (WAN) a personal area network (PAN), a virtual private network (VPN), intranet or another suitable network system.

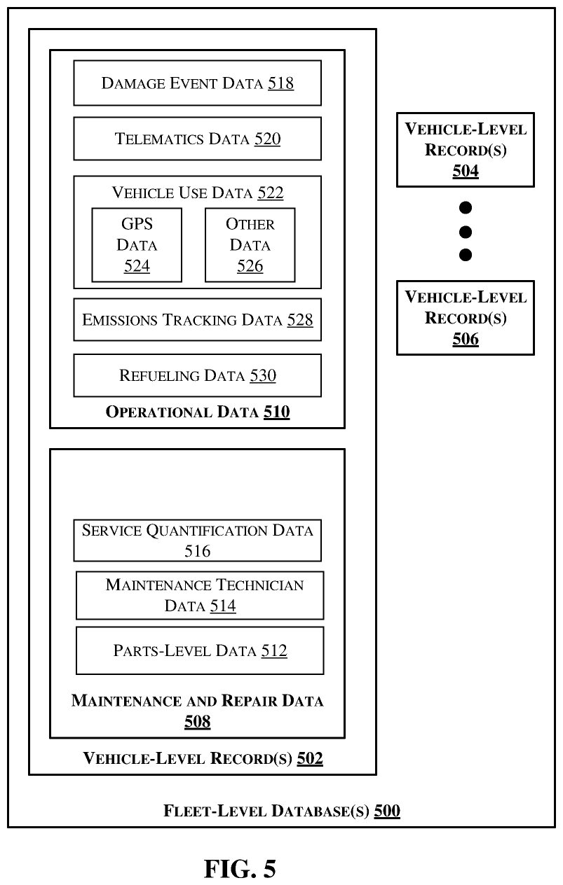

FIG. 4 is a flowchart of an example method 400 for generating a vehicle recommendation indicative of a powertrain change for a vehicle (e.g., the vehicle(s) 105, 205, etc.), according to the present disclosure. FIGS. 4 and 5 may be described with continued reference to prior figures, including FIGS. 1-3. The following process is exemplary and not confined to the steps described hereafter. Moreover, alternative embodiments may include more or less steps that are shown or described herein, and may include these steps in a different order than the order described in the following example embodiments.

Referring first to FIG. 4, at step 405, the method 400 may commence with receiving the operational data associated with one or more vehicle(s) 105. At step 410, the method may include receiving maintenance data associated with the vehicle(s) 105, where the maintenance data includes a parts history of one or more parts associated with the vehicle 105. The operational data (step 405) and the maintenance data (step 410) may be collectively referred to as the vehicle data 115 described with respect to FIG. 1. For example, the processor(s) 305 of the server(s) 125 may receive the vehicle data 115 via the network(s) 120, where the vehicle data 115 includes weather information, GPS information, mileage, sensor data, etc., obtained through vehicle telematics system(s) of the vehicle(s) 105A.

In another example embodiment, information associated with the maintenance of the vehicle(s) 105B may include service quantification data that can quantify (numerically associate) service quality with events observed and recorded using the sensor(s) onboard the vehicle(s) 105B. For example, the vehicle data 115 may include maintenance technical data with an identification of the service technician(s) 160, an identification of the service address, dealership, mechanic's shop, etc., parts-level data indicating one or more parts associated with the vehicle(s) 105B, etc. It should be appreciated that, although not described in great detail, it is known in the art of vehicle tracking and maintenance to associated parts-level data within a database structure to track the life of a product from manufacture to retirement (that is, the date the part exceeds its useful life within the vehicle(s) 105B by replacement, destruction, malfunction, etc.). The maintenance data may include parts data indicative of one or more part replacement(s) associated with the vehicle(s) 105.

When parts are destroyed or replaced, the vehicle data 115 may also provide such an indication. For example, the operational and/or maintenance data (collectively the vehicle data 115) may include damage event data indicative of one or more damage events associated with the vehicle(s) 105. The vehicle data 115 may further include vehicle telematics data indicative of one or more vehicle use metrics associated with the vehicle. Vehicle use metrics can include, for example, a drive time, a drive distance, date information, engine information (RPMs, etc.), braking information, energy usage, battery life information, etc.

In another example, the operational data may include emission tracking data associated with the vehicle(s) 105. In another aspect, the maintenance data comprises a service quantification value indicative of a quality of vehicle service associated with the vehicle(s) 105.

At step 415, the method 400 may further include determining, based at least in part on the operational data and the maintenance data, a total cost of lifecycle ownership for the vehicle(s) 105. The cost of ownership analytics 145 may be a function of one or more analytical tools executed such as, for example, the vehicle maintenance analytics tracking 240 (as shown in FIG. 2), and/or the vehicle operation analytics tracking system 250 (also shown in FIG. 2). For example, those skilled in the art of machine learning appreciate that a machine learning model may be trained using the vehicle data 115 to represent and model a relationship between cost of ownership and one or more drivetrain configurations associated with the fleet 110. Machine learning techniques may differentiate between different fleet configurations (which may be experimentally quantified as part of a database such as the fleet-level database(s) described with respect to FIG. 6) while recognizing their similarities, but also be “stochastic” such that the analytical models may give a prediction interval that identifies a plurality of values, then select an optimal value from the plurality of values. Various techniques for the modeling are contemplated, including direct modeling and a model calibration method.

With respect to the direct modeling method, determining the total cost of ownership may be based at least in part on a Gaussian Process (GP) Model

y(x)=y′(x)+ε,

where y is a value indicative of a cost of ownership associated with one or more fleet configurations x, y′ is an operational variability value, and ε is a value indicative of a zero-mean Gaussian random variable associated with an unknown variance λ, such that λ is associated with an experimental variability. Considering this method in greater detail, the GP model for y^{t}(x) is denoted by,

y′(x)˜GP(m(x),V(x,x′)).

where m(x) and V(x, x′) are the mean function and the covariance function, respectively, of the GP model.

A frequently used form of the mean and covariance functions may be represented by,

$$m ( x ) = {h ( x )}^{T} β , \\ V ( x , {x}^{′} ) = {σ}^{2} exp \{ - {\sum }_{k = 1}^{p} {{ω}_{k} ( {x}_{k} - {x}_{k}^{′} )}^{2} \} ,$$

where p is the dimension of x, i.e. x=(x1, x2, . . . , xp)^{T}. h(x) is a vector of user-predefined polynomial functions used to represent the prior mean, β is a vector of coefficients associated with h(x) for polynomial regression of a mean value, σ is a prior standard deviation for a single random variable in a random process, and ω=[ω1, ω2, . . . , ωp]^{T} is the vector of roughness parameters that can be used to quantify nonlinearity of the process.

Constructing the GP model of the observed response y(x) may be similar to estimating the unknown parameters of the GP, i.e., ϕ={β, σ, ω, λ} by a Maximum Likelihood Estimation (MLE) approach, and thus may be solved using a numerical optimization strategy.

After the most likely values of ϕ are determined, the GP model is fully determined and can subsequently be used to predict the values at other designs. One benefit of using GPR is that GPR can quantify the interpolation uncertainty at the locations that have not yet been tested, and the experimental variability.

With respect to the Calibration model method, determining the total cost of ownership may be based at least in part on a Model Calibration process such that,

y(x)=y^{m}(x)+δ(x)+ε,

where y is a cost of ownership value associated with one or more fleet configurations x, y′ is an operations variability value, δ(x) is a bias function associated with at least one predetermined experimental value, and ε is a value indicative of a zero-mean Gaussian random variable associated with an unknown variance λ, such that λ is an unknown variance associated with an experimental variability.

Using the mean and covariance function equation,

m(x)=b(x)^{T}β.

the concept of GP modeling may be applied by parameterizing δ(x) by {β^{δ}, σ^{δ}, ω^{δ}}. In one example method for tracking the equation, it may be beneficial to generate a GP model for the existing model y^{m}(x) (a “model of the model”, sometimes referred to as a “metamodel”), by {β^{m}, σ^{m}, ω^{m}}. Therefore, the set of unknown parameters ϕto be estimated for this option is {β^{δ}, σ^{δ}, ω^{δ}, β^{m}, σ^{m}, ω^{m}, λ}. In some aspects, it may be computationally more expensive than estimating the smaller parameter set in direct modeling method, but in return the accuracy may be higher, as the Calibration model uses information from y^{m}(x) that is derived from past experience and knowledge.

After determining the total cost of ownership for the vehicle using one or more processes and/or models described above, at step 420, the method 400 may include generating, based at least in part on the total cost of ownership for the vehicle(s) 105, a vehicle recommendation (e.g., one or more of the recommendation(s) 150 and/or 155 in FIG. 1) indicative of a powertrain change for the vehicle(s) 105. In one aspect, generating the vehicle recommendation indicative of the powertrain change for the vehicle can include determining a mean value associated with the total cost of ownership (e.g., the output of step 415), determining a standard deviation value associated with the total cost of ownership, and generating a set of weighted powertrain selection constraints, where the generating includes determining a first standard deviation value associated with a first powertrain design option, determining a second standard deviation value associated with a second powertrain design option, and weighting the first standard deviation value and the second standard deviation value with one or more operations constraint values of a set of predetermined operations constraint values. In other aspects, generating the recommendation may include selecting, based at least in part on the set of weighted powertrain selection constraints and the mean value associated with the total cost of ownership, a selected powertrain change option comprising a minimum predicted cost of ownership associated with one of the first powertrain design option and the second powertrain design option, generating, based at least in part on the selected powertrain change option, a powertrain message comprising the vehicle recommendation, and outputting, via an output device, the vehicle recommendation indicative of the powertrain change for the vehicle. An example output device may be, for example, an output device associated with the fleet manager computing system 135 (shown in FIG. 1).

FIG. 5 depicts an example data structure that may be part of one or more fleet-level database(s) 500. The database(s) 500 are representative databases only, which describe one example for data structures that may be used with embodiments of the present disclosure. With reference to FIG. 5, the fleet-level database(s) 500 may include one or more vehicle-level record(s) 502 associated with maintenance and repair data and operational data for vehicles (e.g., the vehicles 105 in FIG. 1) of a fleet of vehicles (e.g., the fleet 110 in FIG. 1). The fleet-level database(s) 500 (also shown in FIG. 1 as 135) may include a plurality of records associated with vehicle(s) in the fleet 110. For example, the one or more vehicle-level record(s) 502, 504, 506 . . . etc., represent any number of a plurality of vehicle records that may be associated with a vehicle fleet. The vehicle-level record(s) 502 may include, for example, maintenance and repair data 508, and operational data 510. The maintenance and repair data 508 may include information associated with service quality such as, for example, service qualification data 516, maintenance technician data 514, and/or parts-level data 512. Other types of data indicative of maintenance and repair are possible, and are contemplated.

The operational data 510 may include any one or more operational data types, including for example, damage event data 518, telematics data 520, vehicle use data 522, emissions tracking data 528, and/or refueling data 530. The vehicle use data 522 may include information such as, for example, GPS data 524, and/or other data 526 (representing an open-ended category of information that may indicate operational aspects of a vehicle).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation. All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A computer-implemented method, comprising:
receiving operational data associated with a vehicle;
receiving maintenance data associated with the vehicle, the maintenance data comprising a parts history of one or more parts associated with the vehicle;
determining, based at least in part on the operational data and the maintenance data, a total cost of ownership for the vehicle; and
generating, based at least in part on the total cost of ownership for the vehicle, a vehicle recommendation indicative of a powertrain change for the vehicle.

2. The computer-implemented method according to claim 1, wherein the vehicle is operational as one of a fleet of vehicles.

3. The computer-implemented method of claim 2, further comprising determining the total cost of ownership for the fleet of vehicles.

4. The computer-implemented method according to claim 1, wherein the operational data comprises damage event data indicative of one or more damage events associated with the vehicle.

5. The computer-implemented method according to claim 1, wherein the operational data comprises telematics data indicative of one or more vehicle use metrics associated with the vehicle.

6. The computer-implemented method according to claim 1, wherein the operational data comprises vehicle use data comprising Global Positioning System (GPS) information.

7. The computer-implemented method according to claim 1, wherein the operational data comprises emission tracking data associated with the vehicle.

8. The computer-implemented method according to claim 1, wherein the operational data comprises refueling data indicative of a refueling event associated with the vehicle.

9. The computer-implemented method according to claim 1, wherein the maintenance data comprises a service quantification value indicative of a quality of vehicle service associated with the vehicle.

10. The computer-implemented method according to claim 1, wherein the maintenance data comprises maintenance technician data indicative of a technician identifier associated with a maintenance technician that has performed work on the vehicle.

11. The computer-implemented method according to claim 1, wherein the maintenance data comprises part data indicative of a part repair or part replacement associated with the vehicle.

12. The method according to claim 1, wherein determining the total cost of ownership is based at least in part on a Gaussian Process Model y(x)=y′(x)+ε,
wherein y is a value indicative of a cost of ownership associated with one or more fleet configurations x,
wherein y′ is an operational variability value, and
wherein ε is a zero-mean Gaussian random variable associated with an unknown variance λ, such that λ is associated with an experimental variability.

13. The method according to claim 1, wherein determining the total cost of ownership is based at least in part on a Model Calibration process y(x)=y^{m}(x)+δ(x)+ε,
wherein y is a cost of ownership value associated with one or more fleet configurations x,
wherein y′ is an operations variability value,
wherein δ(x) is a bias function associated with a an experimental value, and
wherein ε is a value indicative of a zero-mean Gaussian random variable associated with an unknown variance λ, such that λ is associated with an experimental variability.

14. The method according to claim 1, wherein generating the vehicle recommendation indicative of the powertrain change for the vehicle comprises:
determining a mean value associated with the total cost of ownership;
determining a standard deviation value associated with the total cost of ownership;
generating a set of weighted powertrain selection constraints, the generating comprising:
determining a first standard deviation value associated with a first powertrain design option;
determining a second standard deviation value associated with a second powertrain design option; and
weighting the first standard deviation value and the second standard deviation value with one or more operations constraint values of a set of operations constraint values;
selecting, based at least in part on the set of weighted powertrain selection constraints and the mean value associated with the total cost of ownership, a selected powertrain change option comprising a minimum predicted cost of ownership associated with one of the first powertrain design option and the second powertrain design option;
generating, based at least in part on the selected powertrain change option, a powertrain message comprising the vehicle recommendation; and
outputting, via an output device, the vehicle recommendation indicative of the powertrain change for the vehicle.

15. A system, comprising:
a processor; and
a memory for storing executable instructions, the processor configured to execute the instructions to:
receive operational data associated with the vehicle;
receive maintenance data associated with the vehicle, the maintenance data comprising a parts history of one or more parts associated with the vehicle;
determine, based at least in part on the operational data and the maintenance data, a total cost of ownership for the vehicle; and
generate, based at least in part on the total cost of ownership for the vehicle, a vehicle recommendation indicative of a powertrain change for the vehicle.

16. The system according to claim 15, wherein the operational data and the maintenance data comprises information associated with a fleet of vehicles, and further comprising determining the total cost of ownership for a plurality of one or more vehicles in the fleet of vehicles.

17. The system according to claim 15, wherein the operational data comprises one or more of:
damage event data indicative of one or more damage events associated with the vehicle;
telematics data indicative of one or more vehicle use metrics associated with the vehicle; and
vehicle use data comprising Global Positioning System (GPS) information.

18. The system according to claim 15, wherein the maintenance data comprises one or more of:
emission tracking data associated with the vehicle;
refueling data indicative of a refueling event associated with the vehicle;
service quantification value indicative of a quality of vehicle service associated with the vehicle;
maintenance technician data indicative of a technician identifier associated with a maintenance technician that has performed work on the vehicle; and
part data indicative of a part repair or part replacement associated with the vehicle.

19. The system according to claim 15, wherein determining the total cost of ownership is based at least in part on a Gaussian Process Model y(x)=y′(x)+ε,
wherein y is a value indicative of a cost of ownership associated with one or more fleet configurations x,
wherein y′ is an operational variability, and
wherein ε is a zero-mean Gaussian random variable associated with an unknown variance λ, such that λ is associated with an experimental variability.

20. A non-transitory computer readable storage medium comprising program instructions that, when executed by a processor, cause the processor to perform acts comprising:
receiving operational data associated with a vehicle;
receiving maintenance data associated with the vehicle, the maintenance data comprising a parts history of one or more parts associated with the vehicle;
determining, based at least in part on the operational data and the maintenance data, a total cost of ownership for the vehicle; and
generating, based at least in part on the total cost of ownership for the vehicle, a vehicle recommendation indicative of a powertrain change for the vehicle.
